(19) United States
(12) Patent Application Publication
(10) Pub. No.: US 2007/0128384 A1
(43) Pub. Date: Jun. 7, 2007

(54) Notebook case structure

(76) Inventor: Shui-Yuan My, Taichung County (TW)

Correspondence Address: Shui-Yuan My, P.O. Box 44-2049, Taipei, 10668, TW

(21) Appl. No.: 11/293,076

(22) Filed: Dec. 5, 2005

(51) Int. Cl. B31B 45/00

(52) U.S. Cl. 428/34.1

(57) ABSTRACT

This new invention is related with computer, which specially focuses on light in weight and excellent heat transfer character of high intensity notebook case structure design.

### BACKGROUND OF THE INVENTION

(1) Field of the Invention

This new invention is related with computer, which specially focuses on light in weight and excellent heat transfer character of high intensity notebook case structure design.

(2) Description of the Prior Art

Presently, the material of notebook case is majoring made from Aluminum-Magnesium polymer for providing the characters of light in weight, excellent heat transfer and high intensity etc. As our investigation, above Aluminum-Magnesium polymer is disadvantaged during his high temperature die-casting forming process. Since this polymer are easy to have so-called hole effect during the manufacture process, and therefore to cause notebook case intensity are decreased. In additional, due to this defect (defect rate is about 50%) and no good product can not be recycled, the price of notebook case is always keeping in high and therefore influencing notebook industry promotion.

### SUMMARY OF THE INVENTION

The major purpose for invent this product is to provide a notebook case structure that is light in weight, portable as well as character in high intensity and no drop deformation etc.

The another one purpose for invent this product is to provide a notebook case structure that able to cost down the manufacture cost.

For attach the purposes of above, this new invention notebook case structure is constructed by Aluminum-Magnesium polymer as a inner layer and carbon fiber or glass fiber as a resistant outer layer. And according to the structure, this product is therefore able to provide the characters in light in weight, excellent heat transfer and high intensity.

### BRIEF DESCRIPTION OF THE DRAWINGS

FIG. 1 is cutaway view of this new invention notebook case structure.

FIG. 2 is an enlarged drawing of area A in FIG. 1.

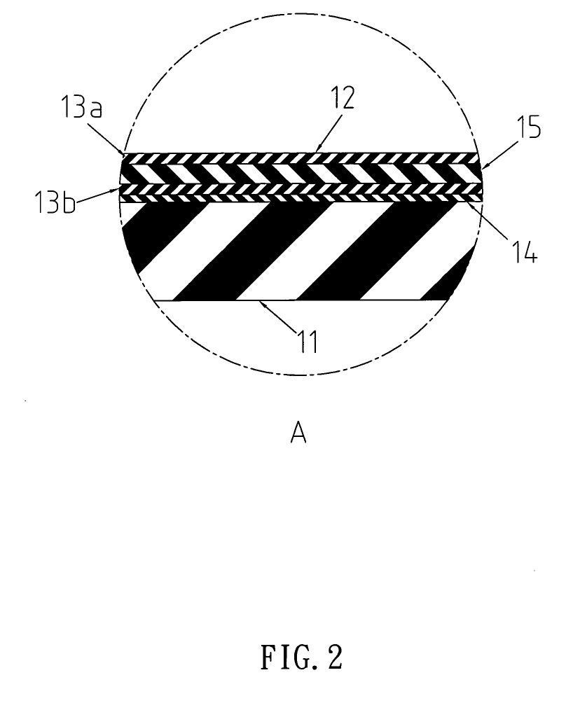

FIG. 3 is cutaway view of this new invention outer layer with resistant.

FIG. 4 is the other cutaway view of this new invention outer layer with resistant.

### DETAILED DESCRIPTION OF PREFERRED-EMBODIMENTS

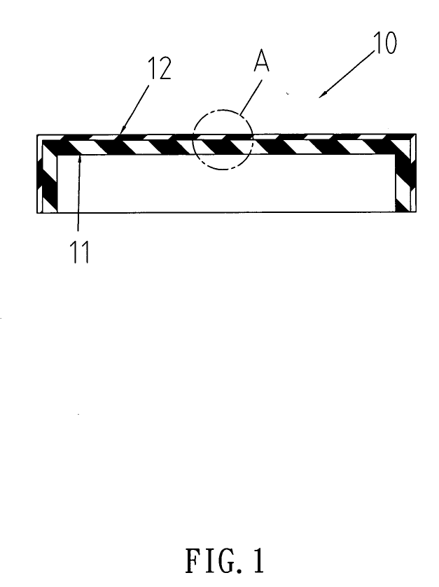

As shown in FIG. 1, this new invention notebook case structure 10 is carbon fiber or glass fiber as a resistant outer layer 12. Within them: The inner layer (11) is made from Aluminum-Magnesium polymer or defected product of Aluminum-Magnesium polymer.

The outer layer (12) is laminated with inner layer 11 by a coated glue layer 14 under the conditions of pressure in 1 cm²/100 kg and temperature in 150° C. for 3 seconds. The resistant outer layer 12 is constructed by carbon fiber or glass fiber 15 as inner body and coated with resin 13a, a3b in the dual surfaces.

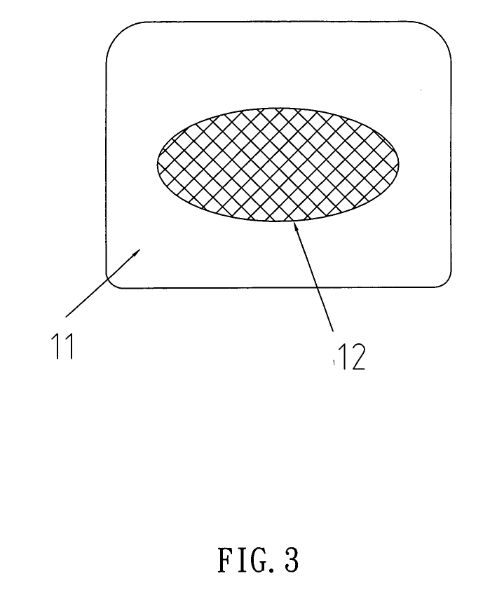

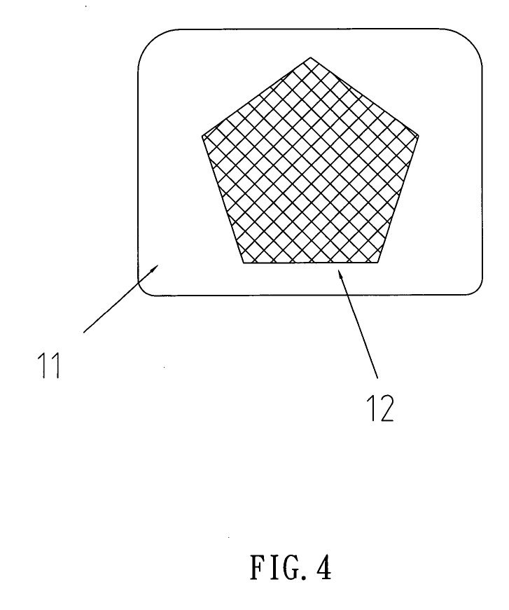

And the size and shape of outer layer 12 is same as inner layer 11 is a circular form or as shown in FIG. 3 and FIG. 4 are multiple-form.

As the description of above, this new invention notebook case 10, is constructed by inner layer 11, glue layer 15, resin layer 13a and 13b as well as carbon fiber or glass fiber. And therefore, this product can provide the characters of high tension, high elasticity and low torque force. This product can cover the uneven intensity problem of Aluminum-Magnesium polymer and improve the intensity into strike duration and no drop deformation level, but still keeps the advantages of light in weigh, excellent heat transfer and portable characters. This product makes the defected Aluminum-Magnesium polymer goods can be reused and promotes the cost goes down in speedily. Therefore this new invention has his advancement and practicability.

To concluded above description, this new invention notebook case 10, majoring design in a carbon fiber or glass fiber with resistant as a outer layer and Aluminum-Magnesium polymer as a inner layer. Then use specific pressure and temperature conditions to combine both of them together. In this new invention, we use high tension, high elasticity and low torque force characters of carbon fiber to increase intensity of Aluminum-Magnesium polymer. And to attach the purpose of this new invention that is to invent a portable, high intensity and no drop deformation notebook case structure. This product makes no good product can be recycled, and therefore save the manufacture cost and green the environment.

What is claimed is:

1. A notebook case structure, which is constructed by a carbon fiber or glass fiber with resistant as a outer layer and Aluminum-Magnesium polymer as a inner layer. Among them:
The inner layer can be a Aluminum-Magnesium polymer or a defected good due to hole effect caused during forming process.
The outer layer is laminated with inner layer by a coated glue layer under high temperature and pressure conditions. The resistant outer layer is constructed by carbon fiber or glass fiber as inner body and coated with resin 13a, a3b as dual surfaces.

2. As the claim 1 mentioned, this new invention is a notebook case structure. The size and shape of outer layer is same as inner layer.
